(19) United States
(12) Patent Application Publication
(10) Pub. No.: US 2024/0305138 A1
(43) Pub. Date: Sep. 12, 2024

(54) CONTACTLESS ELECTRIC POWER TRANSMISSION SYSTEM

(71) Applicant: HONDA MOTOR CO., LTD., Tokyo (JP)

(72) Inventor: Jin Katsuya, Wako-shi (JP)

(21) Appl. No.: 18/582,699

(22) Filed: Feb. 21, 2024

(30) Foreign Application Priority Data
Mar. 10, 2023 (JP) 2023-037344

(51) Int. Cl. H02J 50/12; B60L 53/12

(52) U.S. Cl. CPC H02J 50/12; B60L 53/12

(57) ABSTRACT

A contactless electric power transmission system includes a drive control device and an electric power reception device. The electric power reception device includes an electric power reception portion and a reception electric power conversion portion. The electric power reception portion includes a secondary side coil and a secondary side capacitor. The secondary side coil receives AC electric power transmitted in a contactless manner from the electric power transmission device. The secondary side capacitor is connected in series to the secondary side coil. The reception electric power conversion portion converts the AC electric power received by the electric power reception portion into DC electric power. A control device sets a drive frequency of the electric power transmission device such that an average electric power received by the electric power reception portion in an electric power transmission zone of an electric power transmission device is maximized.

### CROSS-REFERENCE TO RELATED APPLICATION

Priority is claimed on Japanese Patent Application No. 2023-037344, filed on Mar. 10, 2023, the contents of which are incorporated herein by reference.

### BACKGROUND

### Field of the Invention

The present invention relates to a contactless electric power transmission system.

### Background

In recent years, in order to ensure that more people have access to affordable, reliable, sustainable, and advanced energy, research and development relating to charging and electric power supply in a vehicle on which a secondary battery is mounted, which contributes to energy efficiency, has been conducted.

In the related art, in a contactless electric power transmission system that supplies electric power to a vehicle from the outside of the vehicle by contactless electric power transmission, a system is known which sets a frequency of transmission electric power such that received electric power on the vehicle side is maximized (for example, refer to Japanese Unexamined Patent Application, First Publication No. 2009-106136 and Japanese Unexamined Patent Application, First Publication No. 2011-142769).

### SUMMARY

In techniques relating to charging and electric power supply in a vehicle on which a secondary battery is mounted, it is desired to prevent the occurrence of excessive electric power transmission relative to a predetermined rated output and thereby prevent the occurrence of an abnormality in an electric power conversion circuit on the electric power transmission side, an operation of a short circuit protection mechanism, or the like. For example, in the contactless electric power transmission system of the related art described above, when controlling the tracking to an optimum operation point (maximum efficiency) by a frequency tracking control of the electric power conversion circuit on the electric power transmission side, excessive electric power transmission may occur. For example, when performing the frequency tracking control in a design in which desired electric power transmission between sides in which a coil on the electric power transmission side and a coil on the electric power reception side face each other is intended, there is a possibility that a coupling coefficient is increased when the coil on the electric power transmission side and the coil on the electric power reception side span each other (that is, when a movement amount from a relative state becomes a predetermined value or more), and thereby, excessive electric power transmission relative to a rated output set in advance occurs.

An aspect of the present invention aims to provide a contactless electric power transmission system capable of increasing transmitted electric power while maintaining appropriate electric power transmission. Further, the aspect of the present invention contributes to energy efficiency.

A contactless electric power transmission system according to a first aspect of the present invention includes: an electric power reception portion having a coil that receives AC electric power transmitted in a contactless manner from an electric power transmission device and a resonant capacitor connected in series to the coil; an electric power conversion portion that converts the AC electric power received by the electric power reception portion into DC electric power; and a control device that controls an operation of the electric power conversion portion, wherein the control device sets a drive frequency of the electric power transmission device such that an average electric power received by the electric power reception portion in an electric power transmission zone of the electric power transmission device is maximized.

A second aspect is the contactless electric power transmission system according to the first aspect described above which may include: an electric power storage device connected to the electric power conversion portion, wherein the control device may set a request frequency of electric power transmission by the electric power transmission device based on a request electric power in accordance with a residual capacity of the electric power storage device.

According to the first aspect described above, by including the control device that sets the drive frequency of the electric power transmission device such that the average electric power received by the electric power reception portion in the electric power transmission zone of the electric power transmission device is maximized, it is possible to prevent the occurrence of excessive electric power transmission relative to a rated output set in advance. By maximizing the average electric power received by the electric power reception portion, the control device can increase transmitted electric power while maintaining appropriate electric power transmission.

In the case of the second aspect described above, by setting the request frequency of electric power transmission by the electric power transmission device based on the request electric power in accordance with the residual capacity of the electric power storage device, the control device can prevent the increase of charging and discharging of the electric power storage device associated with electric power transmission from the electric power transmission device and electric power consumption for traveling of the vehicle. By preventing the increase of charging and discharging of the electric power storage device, it is possible to prevent the occurrence of heat generation, a lifespan decrease, and the like of the electric power storage device.

### BRIEF DESCRIPTION OF THE DRAWINGS

FIG. 1 is a view showing a configuration of a contactless electric power transmission system of an embodiment of the present invention.

FIG. 2 is a view showing details of the configuration of the contactless electric power transmission system of the embodiment of the present invention.

FIG. 3 is a view showing a configuration of an electric power transmission portion and an electric power reception portion in the contactless electric power transmission system of the embodiment of the present invention.

FIG. 4 is a block diagram showing a functional configuration of a control device in the contactless electric power transmission system of the embodiment of the present invention.

FIG. 5 is a graph view showing an example of a correspondence relationship between a frequency of electric power transmission and an average electric power received by the electric power reception portion in an electric power transmission zone of an electric power transmission device in the contactless electric power transmission system of the embodiment of the present invention.

FIG. 6 is a graph view showing an example of a correspondence relationship between a frequency and an efficiency of electric power transmission in the contactless electric power transmission system of the embodiment of the present invention.

### DESCRIPTION OF EMBODIMENTS

Hereinafter, a contactless electric power transmission system according to an embodiment of the present invention will be described with reference to the drawings.

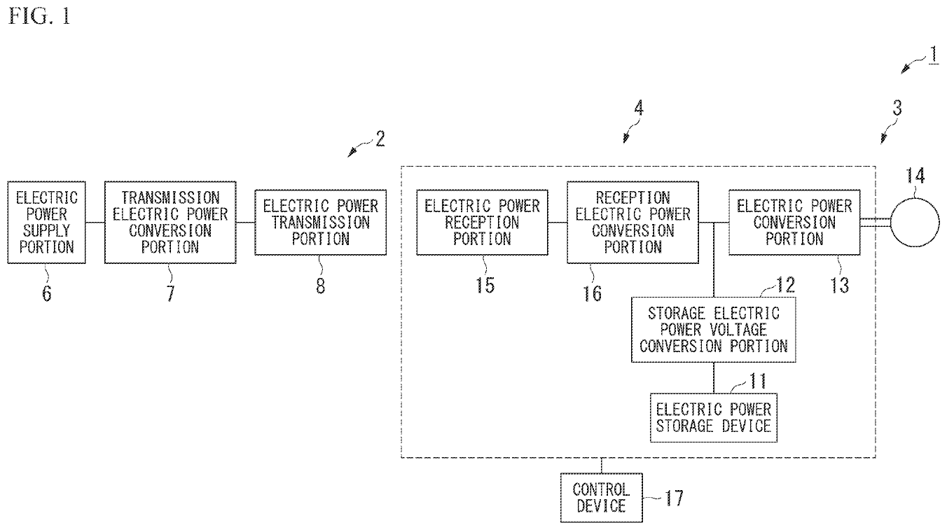

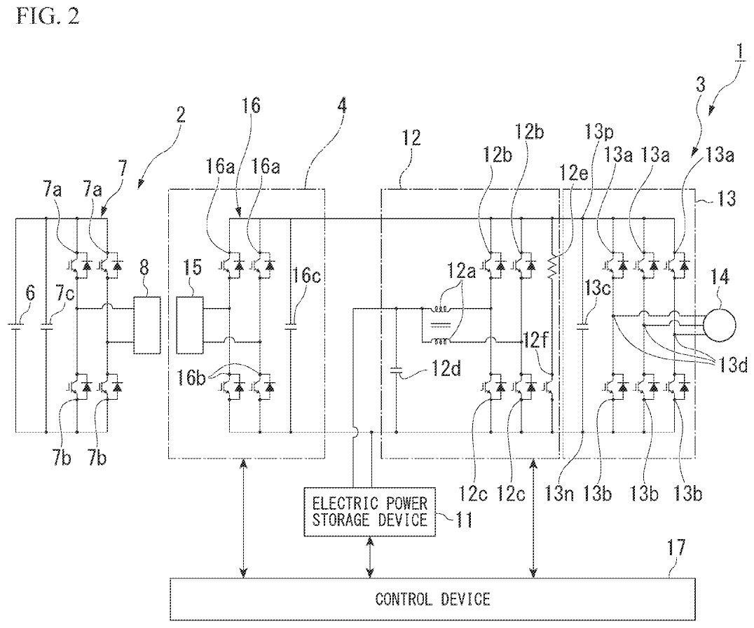

FIG. 1 and FIG. 2 are views showing a configuration of a contactless electric power transmission system 1 of an embodiment. FIG. 3 is a view showing a configuration of an electric power transmission portion 8 and an electric power reception portion 15 of the contactless electric power transmission system 1 in the embodiment.

For example, the contactless electric power transmission system 1 of the embodiment supplies electric power from the outside of a movable body such as a vehicle to the movable body by contactless electric power transmission. The vehicle includes, for example, electric vehicles such as electric automobiles, hybrid vehicles, and fuel cell vehicles.

### Contactless Electric Power Transmission System

As shown in FIG. 1 and FIG. 2, the contactless electric power transmission system 1 of the embodiment includes, for example: an electric power transmission device 2 provided on a travel path or the like of a vehicle; and a drive control device 3, an electric power reception device 4, and an electric power control device 5 that are mounted on a movable body such as a vehicle. The contactless electric power transmission system 1 of the embodiment may include at least configuration elements (for example, the drive control device 3 and the electric power reception device 4) mounted on the movable body, and the contactless electric power transmission may be performed by the combination of a configuration element (for example, the electric power transmission device 2) at the outside of the movable body and the contactless electric power transmission system 1 mounted on the movable body.

The electric power transmission device 2 includes, for example, an electric power supply portion 6, a transmission electric power conversion portion 7, and the electric power transmission portion 8. The electric power transmission device 2 may include, for example, at least a plurality of electric power transmission portions 8 in a predetermined electric power transmission zone on the travel path of the vehicle.

The electric power supply portion 6 includes, for example, an AC electric power supply such as a commercial electric power supply, an AC-DC converter that converts AC electric power into DC electric power, and an electric power smoothing capacitor. The electric power supply portion 6 converts AC electric power supplied from the AC electric power supply into DC electric power by the AC-DC converter.

The transmission electric power conversion portion 7 includes, for example, an inverter that converts DC electric power into AC electric power. The inverter of the transmission electric power conversion portion 7 includes, for example: a bridge circuit formed of a plurality of switching elements connected in two phases by bridge connection and a rectifier element; and a voltage-smoothing capacitor 7c. Each switching element is, for example, a transistor such as a SiC (Silicon Carbide) MOSFET (Metal-Oxide-Semiconductor Field-Effect Transistor). The plurality of switching elements are high-side arm and low-side arm transistors 7a, 7b that form a pair in each phase. The rectifier element is, for example, a reflux diode connected in parallel with each transistor 7a, 7b. The voltage-smoothing capacitor 7c is connected in parallel with the bridge circuit.

The electric power transmission portion 8 transmits electric power by a change of a high-frequency magnetic field, for example, by magnetic field coupling such as magnetic field resonance or electromagnetic induction. As shown in FIG. 3, the electric power transmission portion 8 includes, for example, a resonance circuit formed of a primary side coil 8a, a primary side resistance 8b, and a primary side capacitor 8c that are connected in series. The electric power transmission portion 8 includes, for example, a sensor such as a current sensor that detects a current It flowing through the resonance circuit.

For example, the electric power transmission device 2 performs electric power transmission to the electric power reception device 4 of the vehicle by controlling the switching between ON (conduction) and OFF (cutoff) of each switching element of the transmission electric power conversion portion 7 in response to information of a drive frequency set in advance or a desired frequency received from the electric power reception device 4.

As shown in FIG. 1 and FIG. 2, the drive control device 3 of the vehicle includes, for example, an electric power storage device 11, a storage electric power voltage conversion portion 12, an electric power conversion portion 13, and a rotary electric machine 14. The electric power reception device 4 of the vehicle includes, for example, the electric power reception portion 15 and a reception electric power conversion portion 16. The drive control device 3 and the electric power reception device 4 include, for example, a common control device 17.

For example, in the case of an electric automobile or the like that is driven using the electric power storage device 11 as a power source, the drive control device 3 may not include the storage electric power voltage conversion portion 12. For example, in the case of a hybrid vehicle or the like that is driven using the electric power storage device 11 and an internal combustion engine as a power source, the drive control device 3 may include the storage electric power voltage conversion portion 12.

The electric power storage device 11 is connected to the storage electric power voltage conversion portion 12. The electric power storage device 11 is charged by electric power transmitted in a contactless manner from the electric power transmission device 2 at the outside of the vehicle. The electric power storage device 11 performs transmission and reception of electric power with the rotary electric machine 14 via the storage electric power voltage conversion portion 12 and the electric power conversion portion 13.

The electric power storage device 11 includes, for example, a battery such as a lithium-ion battery, a current sensor that detects a current of the battery, and a voltage sensor that detects a voltage of the battery.

For example, in an electric automobile or the like, when the storage electric power voltage conversion portion 12 is not provided, the electric power storage device 11 is connected to the electric power conversion portion 13 and the reception electric power conversion portion 16 described later.

The storage electric power voltage conversion portion 12 is connected to the electric power conversion portion 13 and the reception electric power conversion portion 16. The storage electric power voltage conversion portion 12 includes, for example, a voltage controller that performs a bi-directional voltage conversion of increasing the voltage and decreasing the voltage.

The voltage controller converts input electric power and output electric power at the time of charging and discharging of the electric power storage device 11 by the bi-directional voltage conversion. The voltage controller of the storage electric power voltage conversion portion 12 includes, for example, a pair of first reactors 12a, 12a, a first element module, and a voltage-smoothing capacitor 12d.

The pair of first reactors 12a, 12a form a composite reactor by being magnetically coupled to each other at opposite polarity. The pair of first reactors 12a, 12a are connected to a connection point between a high side arm and a low side arm of each phase of the first element module.

The first element module includes, for example, a first bridge circuit formed of a plurality of switching elements connected in two phases by bridge connection and a rectifier element. Each switching element is, for example, a transistor such as a SiC MOSFET. The plurality of switching elements are high-side arm and low-side arm transistors 12b, 12c that form a pair in each phase. The rectifier element is, for example, a reflux diode connected in parallel with each transistor 12b, 12c. The voltage-smoothing capacitor 12d is connected in parallel with the electric power storage device 11.

The storage electric power voltage conversion portion 12 includes a resistance 12e and a transistor 12f that are connected in series. The resistance 12e and the transistor 12f are connected in parallel with the first bridge circuit.

The pair of first reactors 12a, 12a and the first element module of the voltage controller perform voltage conversion by so-called two-phase interleaving. In the two-phase interleaving, one cycle of a switching control of a first-phase transistor 12b, 12c of two-phase transistors 12b, 12c connected to the pair of first reactors 12a, 12a and one cycle of a switching control of a second-phase transistor 12b, 12c are displaced from each other by half a cycle.

The electric power conversion portion 13 is connected to the rotary electric machine 14. The electric power conversion portion 13 includes, for example, an electric power converter that performs conversion between DC electric power and AC electric power. The electric power converter includes, for example, a second element module and a voltage-smoothing capacitor 13c.

The second element module includes, for example, a second bridge circuit formed of a plurality of switching elements connected in three phases by bridge connection and a rectifier element. Each switching element is, for example, a transistor such as a SiC MOSFET. The plurality of switching elements are high-side arm and low-side arm transistors 13a, 13b that form a pair in each phase.

The rectifier element is, for example, a reflux diode connected in parallel with each transistor 13a, 13b. The voltage-smoothing capacitor 13c is connected in parallel with the second bridge circuit.

The second element module controls an operation of the rotary electric machine 14 by transmission and reception of electric power. For example, at the time of power running of the rotary electric machine 14, the second element module converts DC electric power input from DC terminals 13p, 13n of a positive electrode and a negative electrode into three-phase AC electric power and supplies the three-phase AC electric power from a three-phase AC terminal 13d to the rotary electric machine 14. The second element module generates a rotation drive force by sequentially commutating electric power supply to a three-phase stator winding of the rotary electric machine 14.

For example, at the time of regeneration of the rotary electric machine 14, the second element module converts the three-phase AC electric power input from the three-phase stator winding into DC electric power by the driving between ON (conduction) and OFF (cutoff) of the switching element of each phase synchronized with the rotation of the rotary electric machine 14. The second element module is capable of supplying the DC electric power converted from the three-phase AC electric power to the electric power storage device 11 via the storage electric power voltage conversion portion 12.

The rotary electric machine 14 is, for example, a three-phase AC brushless DC motor provided for traveling and driving of the vehicle. The rotary electric machine 14 includes a rotor having a field permanent magnet and a stator having a three-phase stator winding that generates a rotation magnetic field which rotates the rotor. The three-phase stator winding is connected to a three-phase AC terminal 13d of the electric power conversion portion 13.

The rotary electric machine 14 generates a rotation drive force by performing a power running operation using electric power supplied from the electric power conversion portion 13. For example, when the rotary electric machine 14 is connectable to a wheel of the vehicle, the rotary electric machine 14 generates a travel drive force by performing the power running operation using electric power supplied from the electric power conversion portion 13. The rotary electric machine 14 may generate electric power by performing a regeneration operation using a rotation power input from the wheel side of the vehicle. When the rotary electric machine 14 is connectable to the internal combustion engine of the vehicle, the rotary electric machine 14 may generate electric power using the power of the internal combustion engine.

The electric power reception portion 15 is connected to the reception electric power conversion portion 16. The electric power reception portion 15 receives electric power by a change of a high-frequency magnetic field transmitted from the electric power transmission portion 8, for example, by magnetic field coupling such as magnetic field resonance or electromagnetic induction. As shown in FIG. 3, the electric power reception portion 15 includes, for example, a resonance circuit formed of a secondary side coil 15a, a secondary side resistance 15b, and a secondary side capacitor 15c that are connected in series. The electric power reception portion 15 includes, for example, a sensor such as a current sensor that detects a current Ir flowing through the resonance circuit.

The reception electric power conversion portion 16 shown in FIG. 1 and FIG. 2 is connected to the electric power conversion portion 13. The reception electric power conversion portion 16 includes a so-called full-bridgeless (or bridgeless and totem-pole) power factor correction (PFC) circuit that converts AC electric power into DC electric power. The so-called bridgeless PFC is a PFC that does not include a bridge rectifier using a plurality of diodes connected by bridge connection. The so-called totem-pole PFC is a PFC that includes a pair of switching elements having the same conductivity type connected (totem-pole connection) in series in the same direction.

The reception electric power conversion portion 16 includes for example: a third bridge circuit formed of a plurality of switching elements connected in two phases by bridge connection and a rectifier element; and a voltage-smoothing capacitor 16c. Each switching element is, for example, a transistor such as a SiC MOSFET. The plurality of switching elements are high-side arm and low-side arm transistors 16a, 16b that form a pair in each phase. The rectifier element is, for example, a reflux diode connected in parallel with each transistor 16a, 16b. The voltage-smoothing capacitor 16c is connected in parallel with the third bridge circuit.

For example, the electric power reception device 4 that includes the electric power reception portion 15 and the reception electric power conversion portion 16 receives electric power transmitted from the electric power transmission device 2 by controlling the switching between ON (conduction) and OFF (cutoff) of each switching element of the reception electric power conversion portion 16 in response to information of a frequency of electric power transmission by the electric power transmission device 2.

The control device 17 integrally controls, for example, the drive control device 3 and the electric power reception device 4 of the vehicle.

The control device 17 is, for example, a software function unit that functions by a predetermined program being executed by a processor such as a CPU (Central Processing Unit). The software function unit is an ECU that includes the processor such as a CPU, a ROM (Read-Only Memory) that stores the program, a RAM (Random-Access Memory) that temporarily stores data, and an electronic circuit such as a timer. At least part of the control device 17 may be an integrated circuit such as a LSI (Large-Scale Integration).

For example, the control device 17 generates a control signal indicating a timing of driving each switching element to ON (conduction) and OFF (cutoff) and generates a gate signal for driving each switching element actually to ON and OFF on the basis of the control signal.

For example, by controlling the switching of each switching element of the electric power reception device 4, the control device 17 performs the power factor correction of the input voltage and the input current while rectifying AC electric power received from the electric power transmission device 2 to DC electric power.

For example, the control device 17 controls an output in accordance with a target output by a synchronous rectification operation that synchronously drives the plurality of switching elements of the electric power reception device 4 to ON and OFF and a short circuit operation that shorts the secondary side coil 15a.

For example, the control device 17 controls the synchronous rectification operation in accordance with the magnitude and the phase of a current generated in the electric power reception portion 15 by electric power transmitted from the electric power transmission device 2, that is, the current Ir flowing through the secondary side coil 15a. The control device 17 controls the plurality of switching elements of the reception electric power conversion portion 16 by soft switching of so-called zero voltage switching (ZVS). In the zero voltage switching (ZVS), in each switching element, a voltage of both ends is set to zero by the discharge of an output capacitance (parasitic capacitance) in an OFF state in a dead time period of each phase, and then, turn-on (switching from an OFF state to an ON state) is performed.

For example, the control device 17 controls the short circuit operation by turning on only the low side arm of each phase while continuing the synchronous rectification operation of the zero voltage switching (ZVS) at the high side arm of each phase of the reception electric power conversion portion 16.

For example, the control device 17 sets a drive frequency (that is, a switching frequency) of the plurality of switching elements in the transmission electric power conversion portion 7 of the electric power transmission device 2 such that an average (average electric power) of electric power received by the electric power reception portion 15 in a predetermined electric power transmission zone of the electric power transmission device 2 is maximized. The control device 17 defines the accuracy of the drive frequency of the electric power transmission device 2 in a predetermined frequency range, for example, so as to realize desired electromagnetic radiation reduction. The predetermined frequency range is, for example, about several hundred Hz to higher and lower frequencies.

For example, the control device 17 sets a frequency (request frequency) required for electric power transmission by the electric power transmission device 2 in accordance with a residual capacity (SOC: State of Charge) of the electric power storage device 11. The control device 17 transmits the request frequency to the electric power transmission device 2 by an appropriate communication between the electric power transmission device 2 and the vehicle. The communication between the electric power transmission device 2 and the vehicle is, for example, a communication by an inductor voltage between the coils 8a, 15a of the electric power transmission device 2 and the electric power reception device 4, a wireless communication by a communication device additionally provided on each of the electric power transmission device 2 and the vehicle, or the like.

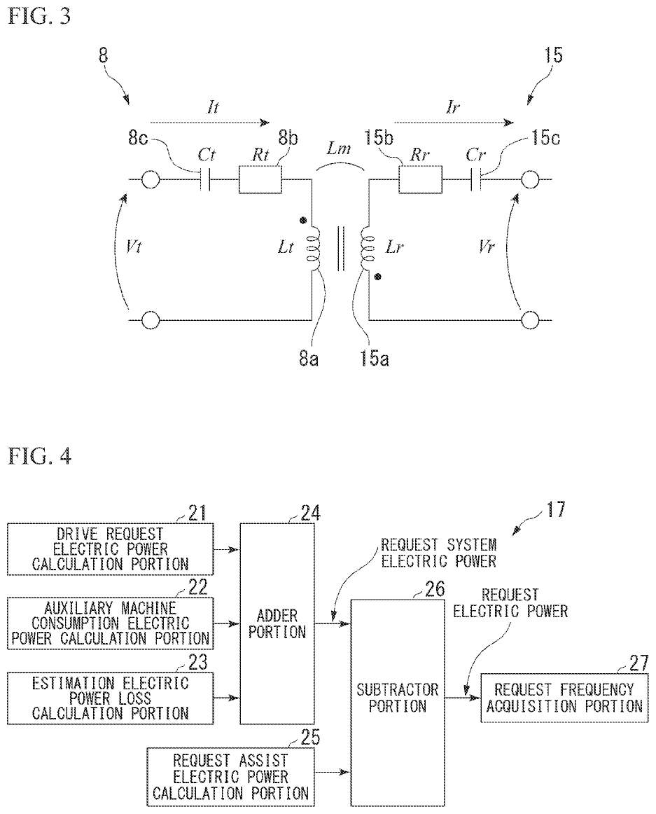

FIG. 4 is a block diagram showing a functional configuration of the control device 17 in the contactless electric power transmission system 1 of the embodiment.

As shown in FIG. 4, the control device 17 includes, for example, a drive request electric power calculation portion 21, an auxiliary machine consumption electric power calculation portion 22, an estimation electric power loss calculation portion 23, an adder portion 24, a request assist electric power calculation portion 25, a subtractor portion 26, and a request frequency acquisition portion 27.

The drive request electric power calculation portion 21 calculates, for example, electric power (drive request electric power) supplied to the rotary electric machine 14 from the electric power conversion portion 13 required in accordance with a target drive force of the rotary electric machine 14 or the vehicle. The target drive force is calculated, for example, based on outputs of various sensors relating to the state of the rotary electric machine 14 or the travel state of the vehicle. The various sensors include, for example: a speed sensor that detects a speed of the vehicle; an accelerator position sensor that detects an accelerator operation amount; a current sensor, a voltage sensor, and a temperature sensor that detect the state of the rotary electric machine 14; and the like.

The auxiliary machine consumption electric power calculation portion 22 calculates consumption electric power (auxiliary machine consumption electric power) of various auxiliary machines connected to the electric power storage device 11, for example, on the basis of the outputs of the various sensors. The various sensors include, for example, a current sensor, a voltage sensor, a temperature sensor, and the like for detecting the state of the electric power storage device 11, consumption electric power of the various auxiliary machines, and the like. The various auxiliary machines include, for example, an electric power converter, an air conditioner, various pumps, and the like.

The estimation electric power loss calculation portion 23 calculates, for example, electric power losses estimated in the storage electric power voltage conversion portion 12, the reception electric power conversion portion 16, and the control device 17.

The adder portion 24 calculates electric power (request system electric power) required for the system by adding the drive request electric power input from the drive request electric power calculation portion 21, the auxiliary machine consumption electric power input from the auxiliary machine consumption electric power calculation portion 22, and the electric power loss input from the estimation electric power loss calculation portion 23.

The request assist electric power calculation portion 25 calculates electric power (request assist electric power) in accordance with a residual capacity (SOC: State of Charge) required based on, for example, ensuring of a desired output of the electric power storage device 11 or the like.

The subtractor portion 26 calculates the request electric power which is a target of electric power received from the electric power transmission device 2 by the electric power reception device 4 by subtracting the request assist electric power input from the request assist electric power calculation portion 25 from the request system electric power input from the adder portion 24.

The request frequency acquisition portion 27 calculates a frequency (request frequency) required for electric power transmission of the electric power transmission device 2 in response to the request electric power input from the subtractor portion 26.

The request frequency acquisition portion 27 acquires the request frequency corresponding to the request electric power, for example, on the basis of data of a correspondence relationship between the output and the frequency of electric power transmission indicating a different characteristic depending on the combination of a magnetic body, a coil, and the like in each of the electric power transmission portion 8 of the electric power transmission device 2 and the electric power reception portion 15 of the electric power reception device 4.

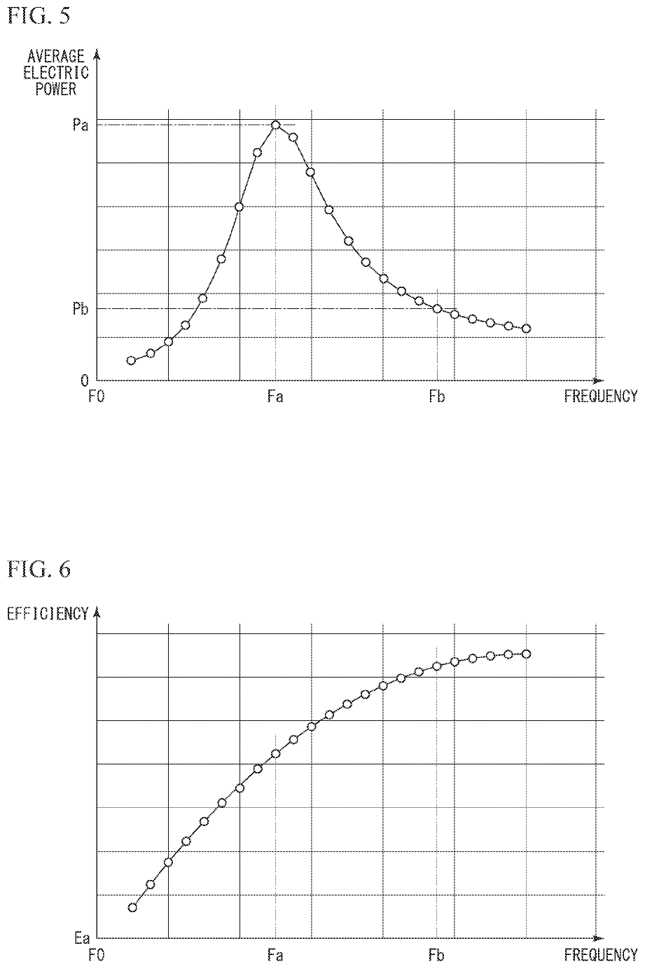

FIG. 5 is a graph view showing an example of a correspondence relationship between a frequency of electric power transmission and an average electric power received by the electric power reception portion 15 in an electric power transmission zone of the electric power transmission device 2 in the contactless electric power transmission system 1 of the embodiment. FIG. 6 is a graph view showing an example of a correspondence relationship between a frequency and an efficiency of electric power transmission in the contactless electric power transmission system 1 of the embodiment.

The correspondence relationship between the average electric power and the frequency shown in FIG. 5 is calculated, for example, on the basis of a minimum ground height of the vehicle and a mounting layout of the electric power reception device 4 in the vehicle which are related to a distance between the primary side coil 8a and the secondary side coil 15a, a state of electric power transmission between the electric power transmission device 2 and the electric power reception device 4 in the electric power transmission zone, an efficiency and an output (electric power) of electric power transmission in the electric power transmission zone, and the like.

As shown in FIG. 6, the electric power transmission in the predetermined electric power transmission zone of the electric power transmission device 2 is performed, for example, in a region where the efficiency of the electric power transmission between the primary side coil 8a and the secondary side coil 15a is equal to or more than a predetermined efficiency Ea. The predetermined efficiency Ea is, for example, 80% or the like.

As shown in FIG. 5, the control device 17 sets, for example, the drive frequency of the electric power transmission device 2 to a predetermined frequency range including a frequency Fa at which the average electric power received by the electric power reception portion 15 in the predetermined electric power transmission zone of the electric power transmission device 2 becomes an appropriate maximum value Pa.

The control device 17 sets, for example, the request frequency with respect to electric power transmission of the electric power transmission device 2 to a frequency Fb corresponding to an appropriate request electric power Pb in accordance with the residual capacity (SOC) of the electric power storage device 11.

As described above, according to the contactless electric power transmission system 1 of the embodiment, by including the control device 17 that sets the drive frequency of the electric power transmission device 2 such that the average electric power received by the electric power reception portion 15 in the electric power transmission zone of the electric power transmission device 2 is maximized, it is possible to prevent the occurrence of excessive electric power transmission relative to a rated output set in advance. By maximizing the average electric power received by the electric power reception portion 15, the control device 17 can increase transmitted electric power while maintaining appropriate electric power transmission.

By setting the request frequency of electric power transmission by the electric power transmission device 2 based on the request electric power in accordance with the residual capacity (SOC) of the electric power storage device 11, the control device 17 can prevent the increase of charging and discharging of the electric power storage device 11 associated with electric power transmission from the electric power transmission device 2 and electric power consumption for traveling of the vehicle. By preventing the increase of charging and discharging of the electric power storage device 11, it is possible to prevent the occurrence of heat generation, a lifespan decrease, and the like of the electric power storage device 11.

### MODIFICATION EXAMPLE

Hereinafter, a modification example of the embodiment is described. The same portions as those of the embodiment described above are denoted by the same reference numerals, and descriptions thereof are omitted or simplified.

The above embodiment is described using an example in which the contactless electric power transmission system 1 includes the storage electric power voltage conversion portion 12 that converts an input-output electric power of the electric power storage device 11. However, the embodiment is not limited thereto, and the storage electric power voltage conversion portion 12 may be omitted.

For example, in the case of a hybrid vehicle or the like that is driven using the electric power storage device 11 and an internal combustion engine as a power source, the drive control device 3 may include the storage electric power voltage conversion portion 12. In the case of an electric automobile or the like that is driven using the electric power storage device 11 as a power source, the drive control device 3 may not include the storage electric power voltage conversion portion 12.

These embodiments of the present invention have been presented as examples and are not intended to limit the scope of the invention. These embodiments can be implemented in a variety of other modes, and various omissions, substitutions, and changes can be made without departing from the scope of the invention. These embodiments and modifications thereof are included in the scope and gist of the invention and are also included in the scope of the invention described in the appended claims and equivalent thereof.

What is claimed is:

1. A contactless electric power transmission system, comprising:
an electric power reception portion having a coil that receives AC electric power transmitted in a contactless manner from an electric power transmission device and a resonant capacitor connected in series to the coil;
an electric power conversion portion that converts the AC electric power received by the electric power reception portion into DC electric power; and
a control device that controls an operation of the electric power conversion portion,
wherein the control device sets a drive frequency of the electric power transmission device such that an average electric power received by the electric power reception portion in an electric power transmission zone of the electric power transmission device is maximized.

2. The contactless electric power transmission system according to claim 1, comprising:
an electric power storage device connected to the electric power conversion portion,
wherein the control device sets a request frequency of electric power transmission by the electric power transmission device based on a request electric power in accordance with a residual capacity of the electric power storage device.
